(19) United States
(12) Patent Application Publication
(10) Pub. No.: US 2017/0031080 A1
(43) Pub. Date: Feb. 2, 2017

(54) Edge-Lit Stepped Light Guide for Downlight Module

(71) Applicants: Richard Speer, Concord, MA (US); David Hamby, Andover, MA (US); Rodrigo M. Pereyra, Salem, MA (US)

(72) Inventors: Richard Speer, Concord, MA (US); David Hamby, Andover, MA (US); Rodrigo M. Pereyra, Salem, MA (US)

(73) Assignee: OSRAM SYLVANIA INC., Danvers, MA (US)

(21) Appl. No.: 14/809,900

(22) Filed: Jul. 27, 2015

(51) Int. Cl. F21V 8/00

(52) U.S. Cl. CPC G02B 6/0036; G02B 6/0031; G02B 6/0073; G02B 6/0088

(57) ABSTRACT

A light guide 2 for a ceiling downlight module 1 provides a batwing light distribution in a compact, flat form factor using edge-lit source light injection. A plurality of solid state light sources 16 inject light from peripheral side surface 12 inward into light guide 2 which has a disc-shaped light guide body 4 having a set of concentric annular steps or faces 42, 44, 46, 48, 50, 52 between which inwardly-facing light-exit rings or facets 24, 26, 28, 30, 32, 34 are formed. Light exiting the ring-shaped facets 24-34 provides substantial light intensity in lateral directions away from a normal optical axis A of light guide 2. Light exiting from facets 24-34 created an advantageous and aesthetically pleasing appearance of lighted rings.

### TECHNICAL FIELD

The present disclosure relates to a light guide for a ceiling downlight module. More particularly, it relates to an edge-lit, disc-shaped light guide having a set of concentric annular steps between which light-exit rings or facets are formed that provide substantial light intensity in lateral directions away from a normal to the light guide body.

### BACKGROUND AND ACKNOWLEDGED PRIOR ART

Osram Sylvania US Pat. Pub. 2012/0320626 (Quilici) shows a downlight. Light guides or lamp optics are known in U.S. Pat. No. 7,160,010 (Chinniah); U.S. Pat. No. 4,860,171 (Kojima); US 2010/0073597 (Bierhuizen); 2008/0112183 (Negley); and 2005/0281052 (Teng); Pub. 2005/0068777 (Popovic); U.S. Pat. No. 7,172,314 (Currie) and D616,141 (Tessnow).

A Philips downlight marketed in the United States under the trade name “Lightolier SlimSurface LED downlight” is a 16 mm (0.625 inch) thick luminaire inserted into a ceiling or wall, provided with either a rectangular or circular light guide panel. One model has a circular light guide edge-lit by light-emitting diodes (LEDs) mounted on a flexible reflective white polyimide printed circuit board (PCB) about 10 mm wide. Components of the luminaire, proceeding from rear (e.g. near a ceiling) to front (light emission face into a room), are: a white reflector sheet; a light guide panel printed with white dots on the bottom which are denser in the center and sparser towards its periphery; a bezel that conceals the LEDs; a diffuser plate; and an anti-glare film 90 (FIG. 9) with a patterned surface facing the area to be illuminated. Viewed under a scanning electron microscope (SEM) the diffuser appears to have a texture of dots each having an approximate diameter of 20 micron. The “Prior Art” FIGS. 9 and 10 show, as viewed under SEM, the anti-glare film 90 appears to have an array of merging circular patterns 92 each consisting of about fourteen concentric circular grooves 94 that mutually merge into adjacent such concentric circular groove patterns, each circular group of concentric grooves 92 having an approximate diameter of 2.4 mm with a groove 94 depth about 30 micron, the groove opening to about 110 degrees.

### BRIEF DESCRIPTION OF THE DRAWINGS

Reference should be made to the following detailed description, read in conjunction with the following figures, wherein like numerals represent like parts:

FIG. 1 is a perspective view of an embodiment of the optic and light source;

FIG. 2 is another view according to FIG. 1 and including reflective cup 20;

FIG. 3 is a side view of the optic and light source of FIG. 2;

FIG. 4 is an exploded view of the optic, light source and reflector of FIG. 3;

FIG. 5 depicts an embodiment of the lamp in a housing 60;

FIG. 6 depicts a top view of light guide 2;

FIG. 7 is a side view of light guide 2 including representative dimensions;

FIG. 8 is representative light output distribution of an embodiment generally in accordance with FIG. 1;

FIG. 9 schematically depicts a portion of a Prior Art anti-glare film 90; and

FIG. 10 is schematic detail of the Prior Art film 90 of FIG. 9.

For a thorough understanding of the present disclosure, reference is made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient. Also, it should be understood that the phraseology and terminology used herein is for the purpose of description and should not be regarded as limiting.

### DETAILED DESCRIPTION INCLUDING BEST MODE OF A PREFERRED EMBODIMENT

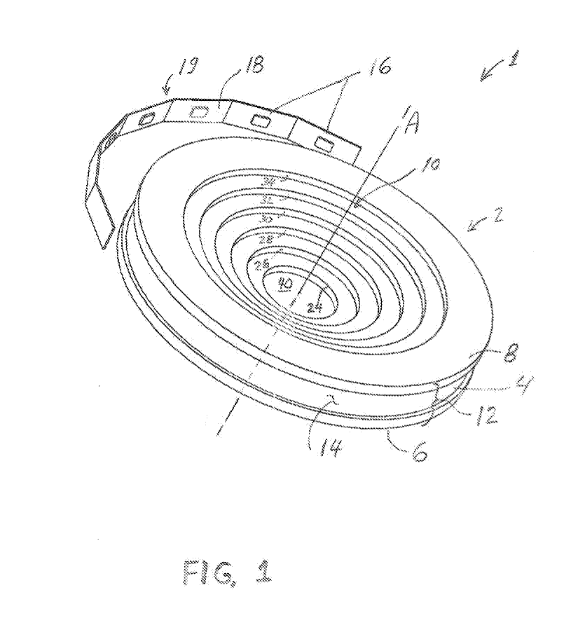

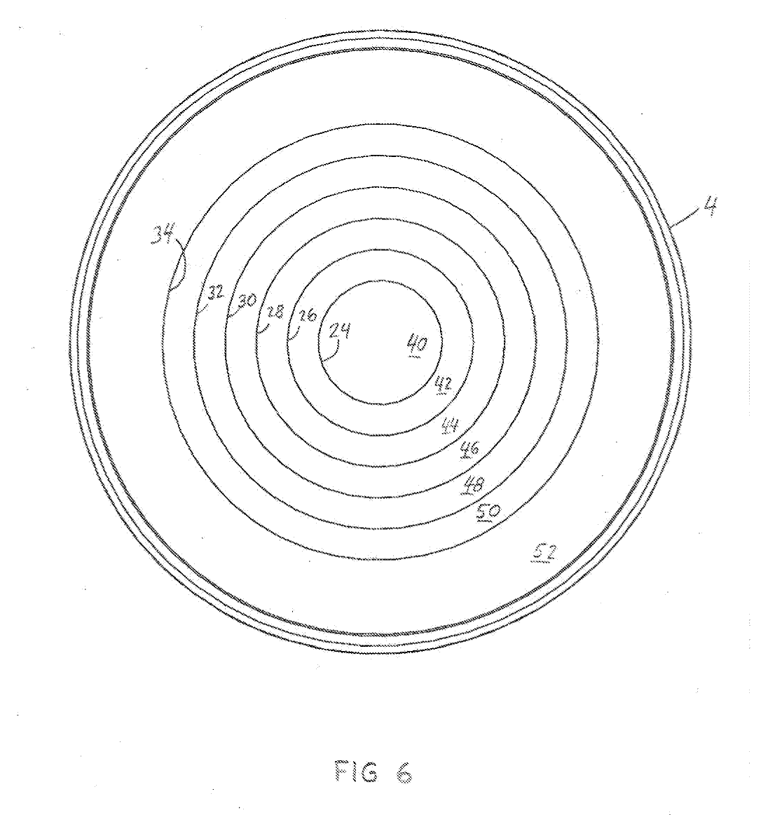

FIG. 1 depicts edge-lit light module 1 having light guide 2 which is surrounded on its outer peripheral side surface 12 with light sources 16. Light guide 2 is shaped like a disc or puck having a stepped pattern of light-emitting facets 24, 26, 28, 30, 32, 34. Light guide 2 has disc-shaped body 4. FIG. 6 shows body 4 is preferably, seen in plan view, generally circular. Preferably body 4 is rotationally symmetric about longitudinal optical axis A as shown in FIG. 1. Light guide 2 can be referred to as an optic. Light guide 2 is formed of polycarbonate (PC), a plastics material which is highly transmissive to visible light. Optionally light guide 2 may be formed of polymethyl metahacrylate (PMMA, referred to as acrylic), or could be formed of glass; a person of skill in the art understands to choose a material, such as a plastics material, suitably transmissive to the wavelength of light emitted by light sources 16.

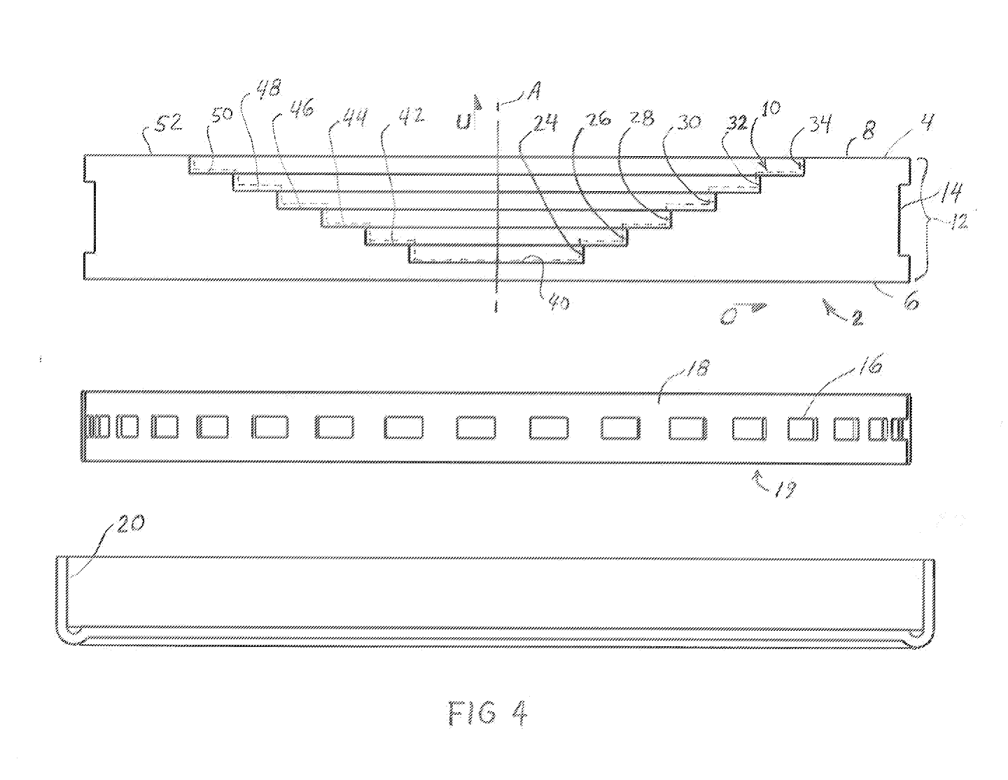

Light guide body 4 has bottom surface 6 and a radially outwardly located peripheral side surface 12. For reference purposes bottom surface 6 can be referred to as a plane tangential to the bottom of light guide body 4 even if the actual form of the bottom deviates from being planer, such as by being concave upward in direction of arrow U (FIG. 4). In a preferred embodiment bottom surface 6 is generally planar or planar. Light guide body 4 has an outer top surface 8 which is opposite bottom surface 6. A portion of top surface 8 is tangent to uppermost annular face 52.

Referring to FIGS. 1, 2, 3 and 4, light guide 2 has top surface 8 spaced above bottom surface 6. It is understood that top surface 8, or the direction indicated by arrow U (FIG. 4) would be directed toward the floor of a room when light module 1 is mounted to a room's ceiling surface as a downlight. Light guide 2 has steps molded or machined (such as cut or milled) into body 4 that form light exit surfaces. Preferably, body 4 defines multiple stepped, concentric ring-shaped facets 24, 26, 28, 30, 32, 34, which for convenience herein can be referred to simply as facets 24, the several facets being of similar form but of progressively larger diameter going from facet 24 closest to optical axis A to facet 34 further radially outward, in direction shown by arrow O (FIG. 4) and thus furthest from axis A. For convenience reference can be made to a particular facet or group of facets with different reference numerals if, for example, a particular relationship between specific facets is being described in more particularity.

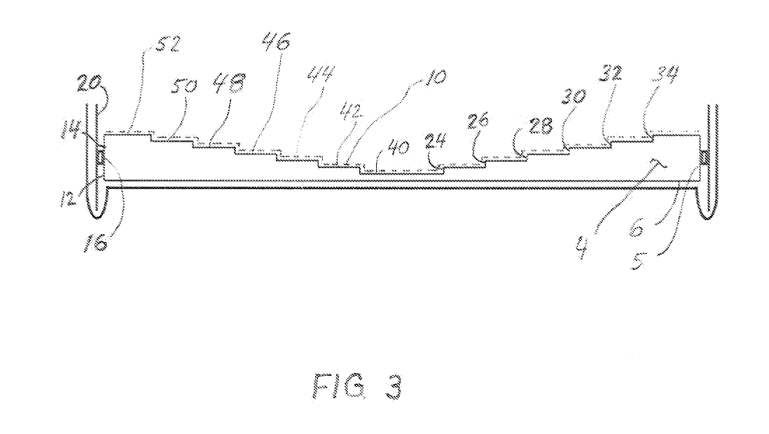

The interior of ring-shaped facet 24 adjoins and encloses floor region 40, thus surrounding floor region 40. Floor region 40 is formed from part of the bulk material of body 4. Floor region 40 is preferably generally planar. Adjacent ring-shaped facets 24, 26 are connected by material of the bulk of body 4 such as step or annular face 42. Successively outwardly adjacent pairs of ring-shaped facets 26, 28 are joined by step or face 44, pair of facets 28, 30 joined by face 46, pair of facets 30, 32 joined by face 48, and pair of facets 32, 34 joined by face 50. Face 52 joins facet 34 to radially-outwardly directed peripheral side surface 12 of light guide 2. Annular faces 42-50 are preferably planar. Referring to FIGS. 1, 3 and 6, preferably there are no voids or spaces in body 4 between pairs of adjacent facets 24-34, since such voids would be air gaps that would introduce more reflective losses and refraction as light passed through body 4 into an air gap and then back into body 4 to finally exit through one of facets 24-34. Referring in particular to FIGS. 3-4, the region in the lateral space facing inward on each of annular facets 24-34 is devoid of material (e.g. plastics material) of the bulk of body 4 since that is the intended air/light guide material (e.g. polycarbonate) interface into which light exits from the material of body 4 through each of facets 24-34 into the space to be illuminated; stated in other words, each of respective facets 24, 26, etc. looks inward, e.g. generally diametrally inward, to an opposing surface of the same facet 24, 26, etc.

The light exit surface 10 is positioned generally opposite bottom surface 6, and light exit surface is the collective light-emitting portions of body 4 out of which light exits from light guide 2 toward the object or room to be illuminated. Light exit surface 10, shown as dashed line boundary in FIGS. 3-4, includes collectively the group of facets 24-34, as light is emitted preferentially from light guide 2 through the facets 24-34 than through annular faces 42-50. Each ring-shaped facet 24-34 defines a respective portion of the light exit surface 10. Optionally, light exit surface 10 is formed collectively of not only the facets 24-34, but also of the respective annular steps or faces 42-50. The annular steps or faces 42-50 extend transverse to, preferably perpendicular to, light entrance window 14. Each successively more radially outwardly (direction arrow O) disposed ring-shaped facet 24-34 is spaced further, as seen in a direction along optical axis A extending from bottom surface 6 in a direction towards top surface 8 (or also in a direction from bottom surface 6 towards light exit surface 10 discussed hereinbelow) than an adjacent more radially-inwardly disposed ring-shaped facet 24-34; for example ring-shaped facet 28 is radially more outward than ring-shaped facet 26 and facet 28 is spaced further, as seen in a direction along optical axis A, from bottom surface 6 than is the adjacent more radially-inward facet 26.

Referring to FIGS. 3-4, steps or annular faces 42-50 are generally transverse to ring-shaped facets 24-34. In preferred embodiments, annular faces 42-50 are perpendicular to ring-shaped facets 24-34, and faces 42-50 are perpendicular to light entrance window 14. In an embodiment shown in FIGS. 3-4, ring-shaped facets 24-34 are generally parallel light entrance window 14, and are also parallel optical axis A.

Side surface 12 of light guide 2 defines light entrance window 14, shown in FIGS. 3-4. Light entrance window 14 is preferably formed as a cylindrical surface. Light engine 19 is positioned at a peripheral side 12 of light guide 2 such that light sources 16 are positioned at light entrance window 14, in particular positioned at first location 5 (FIG. 3) on light entrance window 14. As shown in FIGS. 1, 2 and 4, light entrance window 14 can be groove-shaped and recessed into side surface 12, in order that the groove shape help position and retain light engine 19. First location 5 alongside surface 12 is spaced above bottom surface 6. Light entrance window 14 extends generally perpendicular to top surface 8. As mentioned above, in preferred embodiments a portion of top surface 8 is tangent to uppermost annular face 52, and light entrance window 14 is perpendicular, as seen in FIG. 4, to top surface 8.

The source of light for light guide 2 is a plurality of light sources 16 which are solid state light sources. The term “solid state light source” throughout refers to one or more light emitting diodes (LEDs), organic light emitting diodes (OLEDs), polymer light emitting diodes (PLEDs), organic light emitting compounds (OLECs), and other semiconductor-based light sources, including combinations thereof, whether connected electrically in series, parallel, or combinations thereof. Light sources 16 are preferably light-emitting diodes (LEDs). Light sources 16 preferably emit light into light entrance window 14 generally directed radially inward into the bulk of light guide body 4, thus generally towards optical axis A. Light entering light guide 2 is transmitted in accordance with principles of total internal reflection (TIR) until light striking the right-shaped facets 24-34 at angles less than the relevant critical angle (for the choice of wavelength and material of body 4) cause light to exit though facets 24-34. The pattern of light exiting body 4 can be further influenced through choice of surface texture or additional light extraction elements, or both, on facets 24-34 or annular faces 42-50, or both, as discussed below.

FIG. 4 shows a side view, and FIG. 1 a perspective top view of a flexible light engine 19. Flexible light engine 19 includes a flexible substrate strip 18 and a plurality of solid state light sources 16. Light engine 19 has a 1×n array of LEDs 16 in sufficient quantity to surround peripheral side surface 12. For example, it is adequate to have 4 strings of eight (8) LEDs 16 each, for a total of n=32 LEDs circumferentially spaced around an approximately 6 inch (about 15.2 mm) outer diameter disc-shaped body 4.

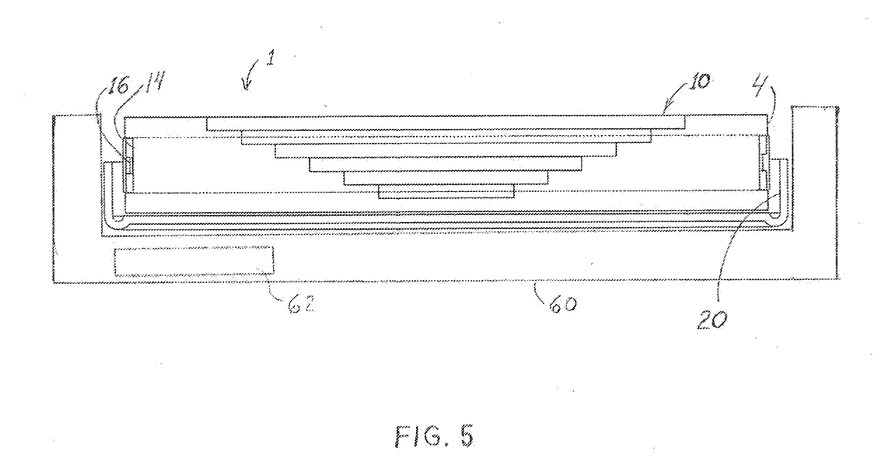

Suitable constructions of a flexible light engine 19 are known in the art such as in published United States patent applications US 2015/0092413 (Li et al.) or US 2015/0092429 (Speer et al.) which are hereby incorporated in their entirety by reference as if fully set forth herein. Reference is made in US 2015/0092413 particularly to paragraphs [0036] to [0042], and in US 2015/0092429 particularly to paragraphs [0041] to [0050] therein. Light engine 19 is also provided with electrical connectors (not shown) such as at ends of the strip, which communicate with electrical traces (not shown) on substrate 18 for making electrical connection to light sources 16. Referring to FIG. 5, driver 62 is illustrated schematically as positioned in mounting base or housing 60 and provides energy to the aforesaid electrical connectors (not shown) of light engine 19.

The term “flexible” when used in reference to flexible light engine 19 or flexible strip 18 refers to a flexible light engine 19 or flexible strip 18 that may be readily bent or flexed compared to a light engine or strip constructed, for example, solely of a rigid substrate such as fiber reinforced epoxy (e.g., FR4) or polyimide. It is appreciated, however, that flexible light engine could be constructed of sub-panels made of rigid FR4 printed circuit board (PCB) each bearing one or more LEDs 16 whereby the sub-panels are connected by resilient hinge sections, whereby the overall assembled light engine 19 is flexible by virtue of its being jointed, as is known in the art. However, it is preferred that substrate strip 18 is made of a flexible material, which permits light engine 19 to be flexible along its overall length.

Flexible substrate 18 may be, and in some embodiments is, formed from any material or combination of materials suitable for use as a flexible substrate for a light engine. In some embodiments, flexible substrate 18 is in the form of an electrically insulating flexible sheet, a woven and/or non-woven material, a flexible composite, combinations thereof, and the like. Flexible substrate 18 may be, for example, and in some embodiments is, formed from any suitably flexible material, such as a polymer, a polymer composite, a polymer fiber composite, a metal, a laminate, and/or combinations thereof. Non-limiting examples of suitable polymer materials that may be used to form such sheets include shapeable polymers such as polyethylene (PE), polypropylene (PP), polyethylene terephthalate (PET), polyimide (PI), polyamides, polyethylene napthalate (PEN), polyether ether ketone (PEEK), combinations thereof, and the like. The conductive traces (not shown) on substrate 18 making electrical connection to light sources 16 may be, and in some embodiments are, formed of any conductive material with conductivity that is sufficient for electrical applications, as is known to those of skill in the art. In some embodiments, for example, the conductive traces are formed of a metal such as copper, silver, gold, aluminum, or the like, that is printed, deposited, and/or plated on a surface of the flexible substrate 18 so as to correspond to a pattern for establishing parallel connections of a plurality of strings of solid state light sources 16 on flexible substrate 18. In some embodiments, for example, the conductive traces are formed on flexible substrate 18 using a known develop-etch-strip (DES) process.

The solid state light sources 16 are electrically coupled to the conductive traces (not shown) on substrate 18 using any suitable material with sufficient conductivity for establishing and/or maintaining an electrical connection between the solid state light sources 16 and the conductive traces, for example, by being electrically coupled to the conductive traces using solder, and in some embodiments, the electrical coupling is achieved through use of an adhesive, wire bonding, die bonding, and the like (all not shown). An adhesive such as an electrically conductive adhesive may be used, such as a conductive epoxy. In such instances the conductive epoxy may include an epoxy binder containing conductive particles, such as particles of silver, gold, copper or the like, with the particles present in the epoxy in sufficient quantity to make the adhesive conductive.

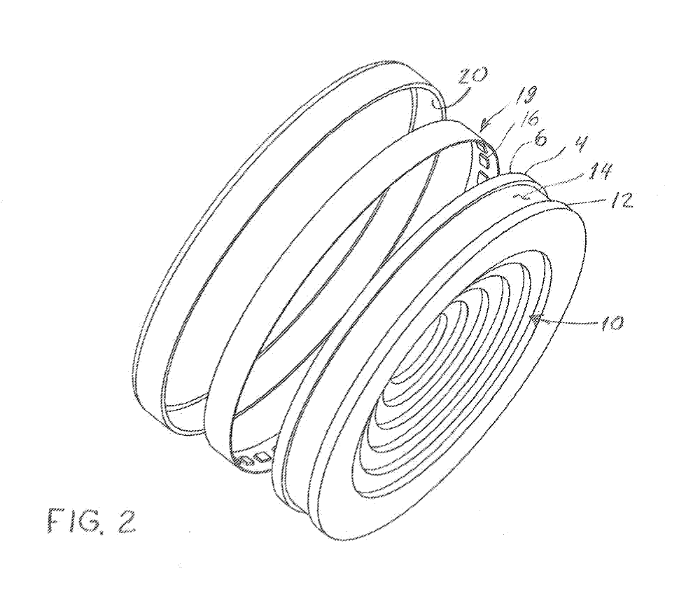

Referring to FIGS. 2, 3, 4 and 5, reflective member 20 is provided under bottom surface 6 of light guide 2. Reflective member 20 can be relatively flat. Reflective member 20 can be a relatively thin, disc-shaped member of about 0.02 in (0.5 mm) thickness which is sized to conform to the diameter of body 4. Reflective member 20 can optionally be a piece of suitably reflective white paper. Reflective member 20 can optionally be a thin disc which is simply in register with, or co-extensive with, bottom surface 6, without extending upwards in register with side surface 12. Reflective member 20 has a reflective surface directed into light guide body 4 so as to reflect light emitted from LEDs 16 back into the bulk of light guide 2. Advantageously, reflective member 20 is cup-shaped so that it extends upward, in direction of optical axis A, behind light sources 16, and more preferably above light guide top surface 8. When formed in a cup shape, reflector 20 is preferably made of thermoformed material of thickness greater than 0.5 mm. Reflector cup 20 cooperates to position light engine 19 adjacent light guide 2. In some embodiments, reflective member 20 exhibits high reflectivity with respect to light originating from LEDs 16. For example, reflector 20 may reflect more than or equal to about 80%, 85%, 90%, 95%, or even more of the light that reaches reflector 20. Reflective member 20 is made of white PET polymer, which is white so as to provide reflectivity. PET can be coated or made with titanium dioxide filler so as to provide reflectivity, and is readily thermoformed into a cup shape. In an embodiment providing advantageous performance, reflective member 20 has about 90% reflectivity to light in the visible wavelength range.

Referring to FIG. 5, light module 1 is advantageously contained in housing 60 which includes schematically-shown driver 62 and (not shown) electrical connections adapted to receive, as is known in the art, electrical energy from an electric mains, such as alternating line current through a conventional screw socket or plug connection which energizes driver 62. Housing 60 also provides a base from which mechanic connection of light module 1 is made to a mounting surface such as ceiling or downlight recess, such as with threaded fasteners (not shown) extending through a rim portion of housing 60.

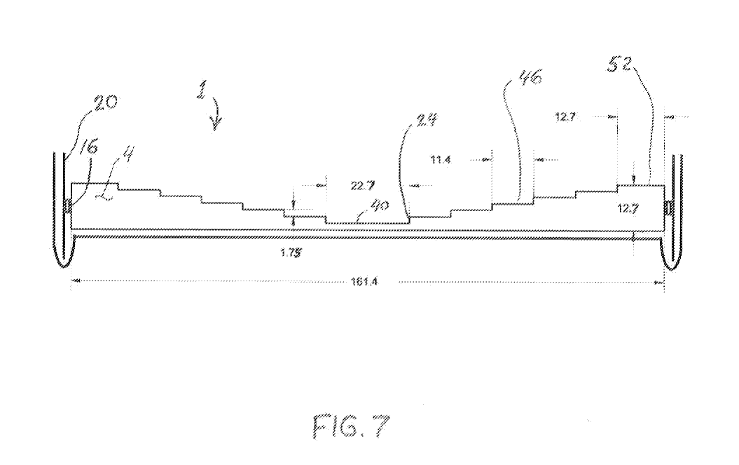

Referring to FIG. 7, in some embodiments, light module 1 is sized to approximate nominal “6-inch diameter” (circa 152 mm) size downlight, a popular size. FIG. 7 shows approximate nominal dimensions of an embodiment of an advantageous light guide 2. Circular disc-shaped body 4 has about 161.4 mm outer diameter and thickness about 12.7 mm (circa 0.5 inch); central floor region 40 has a diameter typically about 22.7 mm; each facet 24-34 rises typically about 1.75 mm from the next lower surface; a typical step or annular face 42-50, e.g. face 46, has a width in radial direction about 11.4 mm (circa 7/16 inch); and an uppermost face 52 joining facet 34 to side surface 12 has a width of about 12.7 mm (circa half-inch), it being understood that annular faces 42-50 can alternatively be formed to be closer to about 12.7 mm.

For a ceiling light or so-called downlight module with which the present embodiment is useful, an advantageous light distribution pattern is referred to as a batwing type of distribution. A batwing distribution has substantial light intensity in lateral directions when compared to the normal direction pointed straight down from the ceiling to the floor. When viewing a batwing type of distribution in a polar plot, showing light intensity vs. angle, one observes that the light intensity smoothly increases, as the observer moves laterally away from straight under the light module (0 degrees), up to a certain angular extent lateral from straight down, after which the intensity typically drops off sharply to zero or near zero.

In operation, when LED light sources 16 are energized, it was observed that an embodiment of light module 1 similar to that depicted in FIGS. 2-5 provides significantly more light at high angles laterally away from the normal direction of optical axis A than the amount of light directed in the normal direction (axis A). An embodiment of light guide 1 used a polycarbonate light guide 2 into which ring-shaped facets 24-34 were machined by milling, shaped generally as in FIG. 4, generally perpendicular to the front face (step 52) of disc 4, with a finish “as received” from milling, and a flat piece of white paper as reflective member 20 placed under bottom surface 6. It was readily observed that intensity of light at 45 degrees from the normal (axis A) is clearly higher than straight on (direction of axis A), and that light exiting from facets 24-34 created an advantageous and aesthetically pleasing appearance of lighted rings. It is understood that texturing the machined steps can allow for more light extraction. The step pattern of annular faces 42-50 and surface texture of light guide 2 can be altered in combination to achieve a desired light distribution.

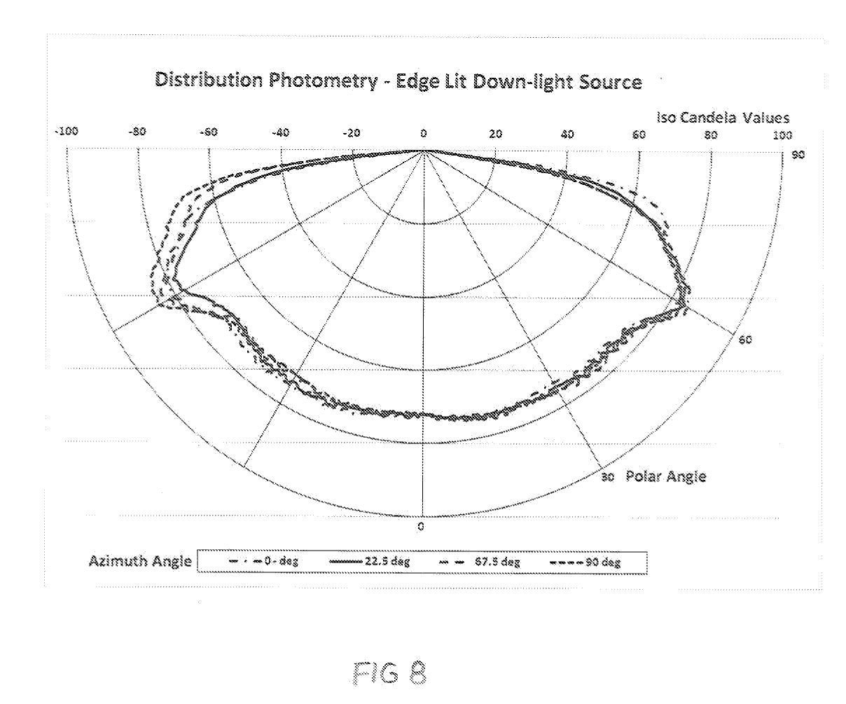

Embodiments disclosed herein advantageously provide a batwing light distribution in a compact, flat form factor using edge-lit source light injection. FIG. 8 shows a batwing light distribution pattern observed with a polar goniometer in use of an embodiment similar to that shown in FIG. 1 in combination with a reflective member 20 in the form of a flat, 0.02 inch (0.5 mm) thick reflective (reflectivity about 90%) PET sheet in circular form approximating the bottom of light guide 2, operating the LED strings at 24V DC. FIG. 8 shows the light distribution observed at four different viewing angles with the illuminated light guide embodiment in the goniometer, and a light detector set at four different azimuth angles, the zero (0) degree angle being along optical axis A, the others spaced respectively 22.5 degrees, 67.5 degrees, and normal (90 degrees) away from axis A. Using a 2-axis gimble, the detector set at each respective angle is then moved around one axis 180 degrees, starting at a side edge approximately at side surface 12 viewing along annular face 52 and then moving around to the opposite portion of side surface 12; a second scan was made at an axis of rotation 90 degrees to the first axis of rotation of the detector, as is known in the field of goniometry. FIG. 8 shows that, at the various measurement locations, the light intensity is at least as high, or slightly higher than, the light intensity directly underneath light guide 2 at the zero angle (corresponding to optical axis A), and that light intensity peaks at about +60 and about −60 degrees from optical axis A of light guide 2.

Referring to FIGS. 3-4, ring-shaped facets 24-34 are generally parallel light entrance window 14, and are also parallel optical axis A. Optionally, some or all facets 24-34 can be angled toward or away from optical axis A. For example, instead of facets 24-34 being generally parallel optical axis A, facets 24-34 can be angled 45 degrees away from optical axis A, not shown, in which configuration their exposed light exit facets would be inclined relative to axis A and incline outward towards uppermost annular face 52. Again, alternatively, annular faces 42-50 can diverge from being perpendicular to optical axis A such as by having one or more grooves (not shown) cut into them.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, are understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The phrase “comprising” in the claims hereinbelow, or in describing features of an embodiment in the written description hereinabove, includes the case of “consisting only of” the described features.

An abstract is submitted herewith. It is pointed out that this abstract is being provided to comply with the rule requiring an abstract that will allow examiners and other searchers to quickly ascertain the general subject matter of the technical disclosure. It is submitted with the understanding that it will not be used to interpret or limit the scope or meaning of the claims, as set forth in the rules of the U.S. Patent and Trademark Office.

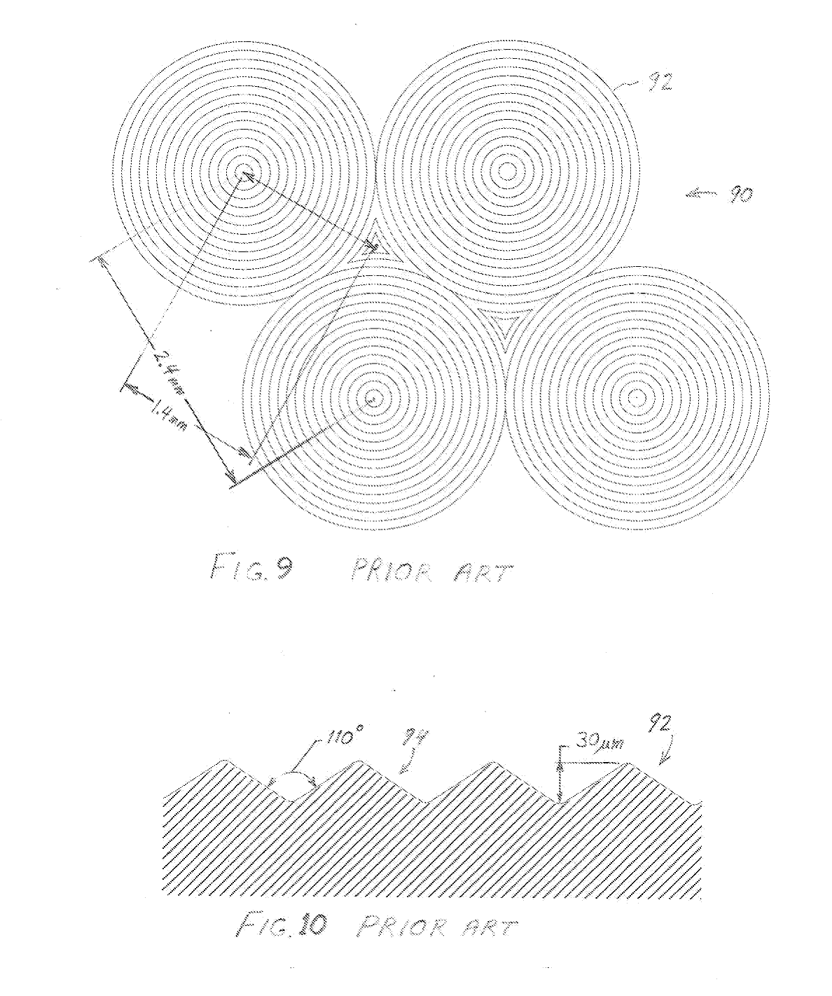

The following non-limiting reference numerals are used in the specification:
1 edge-lit module
2 light guide
4 light guide body
5 first location
6 bottom surface
8 top surface
10 light exit surface
12 peripheral side surface
14 light entrance window
16 solid state light sources
18 substrate strip
19 flexible light engine
20 reflective member
24, 26, 28, 30, 32, 34 ring-shaped light exit facets
40 floor region
42, 44, 46, 48, 50 annular faces
52 uppermost annular face
60 housing
62 driver
90 anti-glare film (Prior Art FIG. 9)
92 circular pattern of grooves 94 (Prior Art FIG. 9)
94 groove (Prior Art FIG. 10)
A longitudinal optical axis
O Outward radial direction arrow (FIG. 4)
U Upward direction arrow (FIG. 4)

What is claimed is:

1. An edge-lit light module (1) for a lamp, comprising,
a light guide (2) having a disc-shaped body (4) rotationally symmetric about an optical axis (A), said body (4) having in top view a circular shape, said body (4) having a bottom surface (6), a light exit surface (10) adapted to output light, said light exit surface (10) being disposed opposite said bottom surface (6), and a radially outwardly located peripheral side surface (12), the side surface (12) defining a light entrance window (14);
a plurality of solid state light sources (16) disposed proximate said side surface (12) and arranged to emit light into said light entrance window (14) generally radially inwards; and
said light exit surface (10) comprising a plurality of concentric, radially inwardly-facing ring-shaped facets (24, 26, 28, 30, 32, 34), and
each successively more radially outwardly-disposed said ring-shaped facet (28; 26) being spaced successively further, as seen in a direction along the optical axis (A) extending from the bottom surface (6) towards the light exit surface (10), from said bottom surface (6) than an adjacent more radially inwardly-disposed said ring-shaped facet (26; 24).

2. The light module of claim 1, wherein each ring-shaped facet (24, 26, 28, 30, 32, 34) defines a respective light exit portion of the light exit surface (10), the ring-shaped facets generally facing the optical axis (A).

3. The light module of claim 1, wherein a radially inward region of each ring-shaped facet (24, 26, 28, 30, 32, 34) directed towards the optical axis (A) defines a cavity external to the body (4).

4. The light module of claim 1, wherein light exit surface (10) is collectively defined by a plurality of the ring-shaped facets (24, 26, 28, 30, 32, 34).

5. The light module of claim 1, wherein adjacent said ring-shaped facets (24, 26, 28, 30, 32, 34) are connected by respective annular faces (42, 44, 46, 48, 50) which extend generally transverse to said light entrance window (14).

6. The light module of claim 5, wherein said annular faces (42, 44, 46, 48, 50) further comprise light extraction elements.

7. The light module of claim 5, wherein said annular faces (42, 44, 46, 48, 50) further comprise a surface texture configured to promote light extraction.

8. The light module of claim 5, wherein said annular faces (42, 44, 46, 48, 50) are generally planar.

9. The light module of claim 1, wherein a radially innermost ring-shaped facet (24) surrounds and adjoins a generally planar floor region (40).

10. The light module of claim 1, wherein each ring-shaped facet (24, 26, 28, 30, 32, 34) is substantially parallel said light entrance window (14).

11. The light module of claim 1, wherein said light entrance window (14) is formed as a cylindrical surface.

12. The light module of claim 1, wherein
said body (4) further defines a top surface (8) tangent an uppermost said annular face (52); and
said light entrance window (14) extends perpendicular, as seen in cross-section, to said top surface (8).

13. The light module of claim 1, wherein said plurality of solid state light sources (16) are mounted on a flexible printed circuit board (18).

14. The light module of claim 1, further comprising a reflective member (20) disposed in register with said body (4) and arranged to reflect light originating from said solid state light sources (16) into said body (4).

15. The light module of claim 14, wherein said reflective member (20) is arranged radially outward said plurality of solid state light sources (16) and surrounding said peripheral side surface (12).

16. The light module of claim 1, wherein said body (4) has an outer diameter about 15 cm.

17. The light module of claim 1, wherein said ring-shaped facets (24, 26, 28, 30, 32, 34) are machined into said body (4), said body being formed from a light-transmissive plastics material.

18. The light module of claim 1, wherein said ring-shaped facets (24, 26, 28, 30, 32, 34) are molded with said body (4) from a light-transmissive plastics material.

19. The light module of claim 1, wherein said body (4) is formed from one of a light-transmissive polycarbonate material or a light-transmissive acrylic material.

20. The light module of claim 1, wherein said bottom surface (6) is planar.
